(19) United States
(12) Patent Application Publication
(10) Pub. No.: US 2012/0078628 A1
(43) Pub. Date: Mar. 29, 2012

(54) HEAD-MOUNTED TEXT DISPLAY SYSTEM AND METHOD FOR THE HEARING IMPAIRED

(76) Inventor: MAHMOUD M. GHULMAN, Jeddah (SA)

(21) Appl. No.: 12/892,711

(22) Filed: Sep. 28, 2010

(51) Int. Cl. G10L 15/26; G09G 5/00; G10L 21/06

(52) U.S. Cl. 704/235; 704/271; 704/E15.043; 704/E21.019; 345/8

(57) ABSTRACT

The head-mounted text display system for the hearing impaired is a speech-to-text system, in which spoken words are converted into a visual textual display and displayed to the user in passages containing a selected number of words. The system includes a head-mounted visual display, such as eyeglass-type dual liquid crystal displays or the like, and a controller. The controller includes an audio receiver, such as a microphone or the like, for receiving spoken language and converting the spoken language into electrical signals. The controller further includes a speech-to-text module for converting the electrical signals representative of the spoken language to a textual data signal representative of individual words. A transmitter associated with the controller transmits the textual data signal to a receiver associated with the head-mounted display. The textual data is then displayed to the user in passages containing a selected number of individual words.

### BACKGROUND OF THE INVENTION

1. Field of the Invention

The present invention relates to devices to assist the hearing impaired, and particularly to a head-mounted text display system and method for the hearing impaired that uses a speech-to-text system or speech recognition system to convert speech into a visual textual display that is displayed to the user on a head-mounted display in passages containing a selected number of words.

2. Description of the Related Art

Devices that provide visual cues to hearing impaired persons are known. Such visual devices are typically mounted upon a pair of spectacles to be worn by the hearing impaired person. These devices are typically provided for live performances and are wired into a centralized hub for delivering text or visual cues to the wearer throughout the performance. Such devices, though, typically have limited display capabilities and are not synchronized to the actual speech of the performance. Accordingly, there remains a need to provide sufficient information within a wearer's field of view, which can be synchronized with a performance or presentation.

Additionally, heads-up displays for pilots and the like are known. However, such systems are bulky, complicated and expensive, and are generally limited to providing parametric information, such as speed, range, fuel, and the like. Such devices fail to provide sequences of several words that can be synchronized to a performance or presentation being viewed by the wearer. Other considerations, such as the aesthetic undesirability of using a bulky heads-up display in a classroom, movie theater or the like, also prevents such devices from being commercially acceptable. Therefore, conventional heads-up displays fail to address the needs of hearing-impaired persons or those wishing to view a performance or presentation in a language other than that in which the presentation is being made. Thus, a head-mounted text display system and method for the hearing impaired solving the aforementioned problems is desired.

### SUMMARY OF THE INVENTION

The head-mounted text display system for the hearing impaired is a speech-to-text system in which spoken words are converted into a visual textual display and displayed to the user in passages containing a selected number of words. The head-mounted text display system for the hearing impaired includes a head-mounted visual display, such as eyeglass-type dual liquid crystal displays (dual LCDs) or the like, and a controller. The controller includes an audio receiver, such as a microphone or the like, for receiving spoken language and converting the spoken language into electrical signals representative of the spoken language.

The controller further includes a speech-to-text module for converting the electrical signals representative of the spoken language to a textual data signal representative of individual words. A receiver is in communication with the head-mounted visual display, and a transmitter associated with the controller transmits the textual data signal to the receiver. The textual data representative of the individual words is then displayed to the user in passages containing a selected number of individual words, e.g., a display of three words at a time.

Preferably, the controller further includes memory containing a database of video data representative of individual words, such as graphical depictions of sign language. Following speech-to-text conversion, the controller further matches each word to a corresponding visual image in the database. The textual data signal and the corresponding video data are transmitted simultaneously to the receiver, and the textual data and the corresponding video images may then be displayed simultaneously to the user.

These and other features of the present invention will become readily apparent upon further review of the following specification and drawings.

### BRIEF DESCRIPTION OF THE DRAWINGS

FIG. 1 is an environmental, perspective view of a head-mounted text display system for the hearing impaired according to the present invention.

FIG. 2A is a front view of an exemplary visual display presented to the user by the head-mounted text display system for the hearing impaired of FIG. 1.

FIG. 2B is a front view of an exemplary subsequent visual display presented to the user by the head-mounted text display system for the hearing impaired following the display shown in FIG. 2A, FIGS. 2A and 2B representing a single spoken phrase.

FIG. 3 is a block diagram illustrating elements of a controller of the head-mounted text display system for the hearing impaired according to the present invention.

FIG. 4 is a perspective view of a head-mounted display of the head-mounted text display system for the hearing impaired according to the present invention.

Similar reference characters denote corresponding features consistently throughout the attached drawings.

### DETAILED DESCRIPTION OF THE PREFERRED EMBODIMENTS

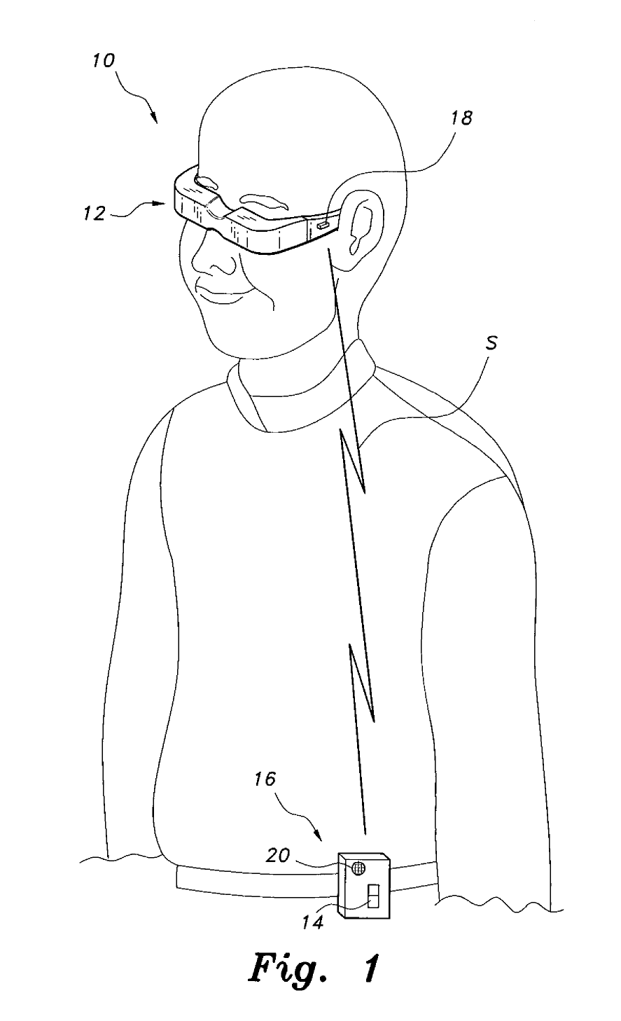

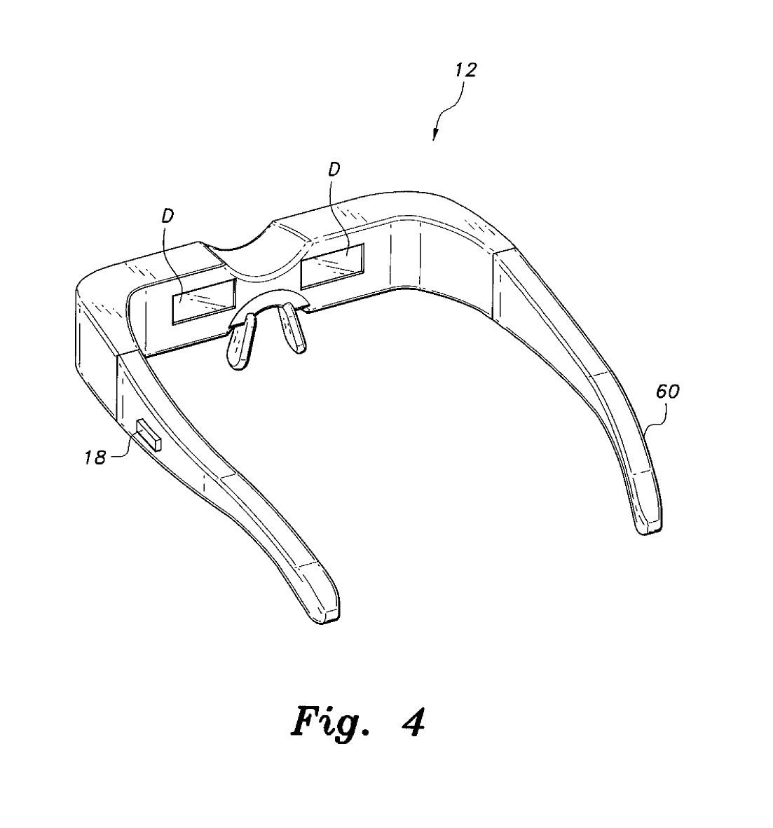

The head-mounted text display system for the hearing impaired 10 is a speech-to-text system in which spoken words are converted into a visual textual display and displayed to the user in passages containing a selected number of words. As shown in FIG. 1, the head-mounted text display system for the hearing impaired 10 includes a head-mounted visual display 12 and a controller 14. In FIG. 1, the head-mounted visual display 12 is shown as an eyeglass-type dual liquid crystal display (dual LCD). As best shown in FIG. 4, such a display 12 includes a pair of liquid crystal displays D, mounted in an eyeglass type frame, with each display D covering a respective one of the user's eyes. Such displays are well known in the field of virtual reality displays. One such display is the MYVU® Shades 301, manufactured by the MicroOptical Corporation of Westwood, Mass. A similar display is shown in PCT patent application WO 99/23524, published on May 14, 1999 to the MicroOptical Corporation, which is hereby incorporated by reference in its entirety. It should be understood that any suitable type of visual display may be utilized.

The controller 14 includes an audio receiver 20, such as a microphone or the like, for receiving spoken language and converting the spoken language into electrical signals representative of the spoken language. It should be understood that any suitable type of audio receiver, microphone or sensor may be used. Further, although shown as being body-mounted in FIG. 1, it should be understood that the controller 14 may be a stand-alone unit (i.e., not carried by the user), or may be integrated into the head-mounted display 12.

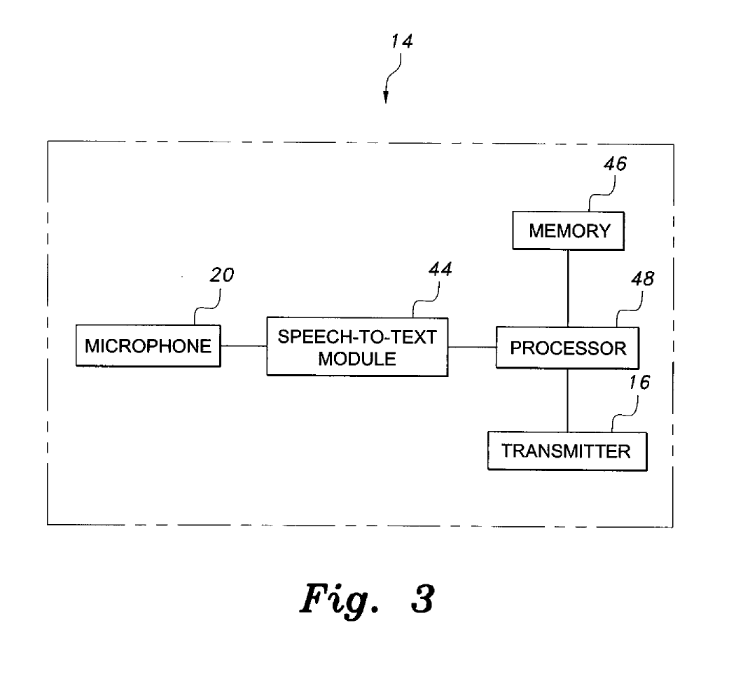

As best shown in FIG. 3, the controller 14 further includes a speech-to-text module 44 for converting the electrical signals (produced by microphone 20) representative of the spoken language to a textual data signal representative of individual words. The speech-to-text module 44 may be a stand-alone unit, or may be in the form of speech recognition software stored in computer readable memory 46 and executable by the processor 48. Speech-to-text systems and modules are well known in the art, and it should be understood that any suitable type of speech-to-text system or module may be utilized. Examples of such systems are shown in U.S. Pat. Nos. 5,475,798; 5,857,099; and 7,047,191, each of which is herein incorporated by reference in its entirety.

The controller 14 preferably includes a processor 48 in communication with computer readable memory 46. As noted above, the speech-to-text module 44 may be a stand-alone unit in communication with processor 48 and memory 46, or may be in the form of software stored in memory 46 and implemented by the processor 48. Speech-to-text or speech recognition software is well known in the art, and any suitable such software may be utilized. An example of such software is Dragon Naturally Speaking, manufactured by Nuance® Communications, LLC of Burlington, Mass.

It should be understood that the controller 14 may be, or may incorporate, any suitable computer system or controller, such as that diagrammatically shown in FIG. 3. Data may be entered into the controller 14 by any suitable type of user interface, along with the input signal generated by the microphone 20, and may be stored in memory 46, which may be any suitable type of computer readable and programmable memory. Calculations and processing are performed by a processor 48, which may be any suitable type of computer processor, microprocessor, microcontroller, digital signal processor, or the like, and may be transmitted to the head-mounted display 12 by any suitable type of wireless transmitter 16, which is preferably a wireless transmitter.

The processor 48 may be associated with, or incorporated into, any suitable type of computing device, for example, a personal computer or a programmable logic controller. The transmitter 16, the microphone 20, the speech-to-text module 44, the processor 48, the memory 46 and any associated computer readable recording media are in communication with one another by any suitable type of data bus, as is well known in the art.

Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 46, or in place of memory 46, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

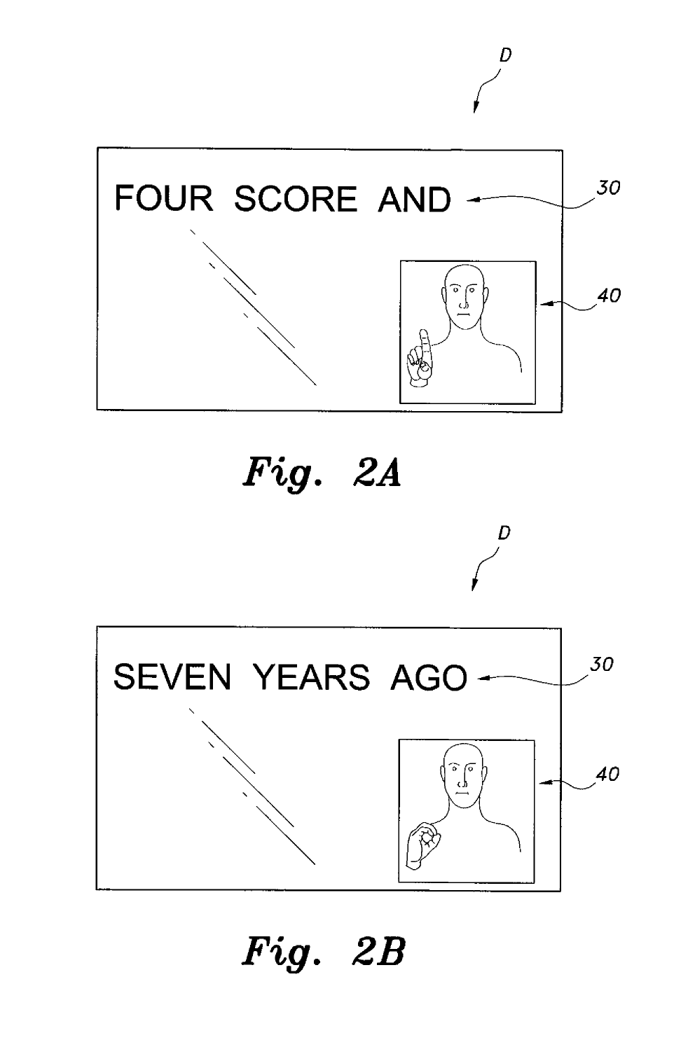

The wireless signal S containing the textual data generated by transmitter 16 is received by a receiver 18 in communication with the head-mounted visual display 12. The textual data representative of the individual words is then displayed to the user in passages containing a selected number of individual words, e.g., a display of three words at a time. In FIGS. 2A and 2B, exemplary three-word passages 30, 32, respectively, are shown being displayed on a display D. As shown, the words are presented to the user three words at a time, allowing the user to easily read each passage, regardless of the speed in which the original speaker speaks the spoken language or the display speed of the particular head-mounted display device.

Preferably, the memory 46 of controller 14 includes a database of video data representative of individual words, such as graphical depictions of sign language. Following speech-to-text conversion, the processor 48 of controller 14 further matches each word to a corresponding visual image in the database. The textual data signal and the corresponding video data are transmitted simultaneously to the receiver 18, and the textual data and the corresponding video images may then be displayed simultaneously to the user. In FIGS. 2A and 2B, a sign language display 40 is shown adjacent the textual displays 30, 32. The graphical display 40 allows for simultaneous display of sign language with the textual display. The user may selectively display only text, only the graphical display, or both simultaneously. In addition to providing the option of the graphical display, the system 10 may also provide translation capability. The speech-to-text subsystem may be in communication with one or more databases containing language translation, allowing the user to select a particular language to be displayed to the user, independent of the language of the speaker. Such speech-to-text translation systems and software are well known in the art. An example of such a system is shown in U.S. Pat. No. 7,747,434, which is herein incorporated by reference in its entirety.

It is to be understood that the present invention is not limited to the embodiments described above, but encompasses any and all embodiments within the scope of the following claims.

I claim:

1. A method of visually displaying spoken text for the hearing impaired, comprising the steps of:
receiving spoken language;
converting the spoken language to textual data representative of individual words;
transmitting the textual data to a receiver in communication with a visual display; and
displaying the textual data to the user, wherein the textual data is displayed to the user in passages containing a selected number of individual words.

2. The method of visually displaying spoken text for the hearing impaired as recited in claim 1, further comprising the step of mounting the visual display and the receiver on the user's head.

3. The method of visually displaying spoken text for the hearing impaired as recited in claim 2, further comprising the step of covering at least one of the user's eyes with the visual display.

4. The method of visually displaying spoken text for the hearing impaired as recited in claim 3, further comprising the steps of:
converting the spoken language to video data representative of the individual words;
transmitting the video data to the receiver; and
displaying the video data simultaneously with the display of the textual data, wherein the video data corresponds to the textual data being displayed to the user.

5. The method of visually displaying spoken text for the hearing impaired as recited in claim 4, wherein the step of converting the spoken language to the video data representative of the individual words comprises converting the spoken language to a graphical representation of sign language.

6. The method of visually displaying spoken text for the hearing impaired as recited in claim 5, wherein the steps of transmitting the textual and video data to the receiver comprise wirelessly transmitting the textual and video data.

7. The method of visually displaying spoken text for the hearing impaired as recited in claim 1, wherein the step of displaying the textual data to the user comprises displaying the textual data in passages containing three words at a time.

8. A method of visually displaying spoken text for the hearing impaired, comprising the steps of:
receiving spoken language;
converting the spoken language to textual data representative of individual words;
converting the spoken language to video data representative of the individual words;
transmitting the textual data and the video data to a receiver in communication with a visual display; and
simultaneously displaying the textual data and the video data to the user, wherein the textual data is displayed to the user in passages containing a selected number of individual words, the video data corresponding to the textual data being displayed to the user.

9. The method of visually displaying spoken text for the hearing impaired as recited in claim 8, further comprising the step of mounting the visual display and the receiver on the user's head.

10. The method of visually displaying spoken text for the hearing impaired as recited in claim 9, further comprising the step of covering at least one of the user's eyes with the visual display.

11. The method of visually displaying spoken text for the hearing impaired as recited in claim 10, wherein the step of converting the spoken language to the video data representative of the individual words comprises converting the spoken language to a graphical representation of sign language.

12. The method of visually displaying spoken text for the hearing impaired as recited in claim 11, further comprising the step of translating the spoken language into a selected second language, the textual data being displayed to the user in the second language.

13. The method of visually displaying spoken text for the hearing impaired as recited in claim 12, wherein the step of simultaneously displaying the textual data and the video data to the user comprises displaying the textual data in passages containing three words at a time.

14. A head-mounted text display system for the hearing impaired, comprising:
a head-mounted visual display;
an audio receiver having a transducer for receiving spoken language and converting the spoken language into electrical signals representative of the spoken language;
means for converting the electrical signals representative of the spoken language to a textual data signal representative of individual words;
a receiver in communication with the head-mounted visual display;
a transmitter for transmitting the textual data signal to the receiver; and
means for displaying the textual data representative of the individual words to the user in passages containing a selected number of individual words.

15. The head-mounted text display system for the hearing impaired as recited in claim 14, further comprising:
means for converting the spoken language to video data representative of the individual words, the video data being transmitted to the receiver with the textual data signal; and
means for displaying the video data simultaneously with the display of the textual data, wherein the video data corresponds to the textual data being displayed to the user.

16. The head-mounted text display system for the hearing impaired as recited in claim 15, wherein the video data comprises a graphical representation of sign language.

17. The head-mounted text display system for the hearing impaired as recited in claim 15, wherein the transmitter is a wireless transmitter.

18. The head-mounted text display system for the hearing impaired as recited in claim 17, wherein the receiver is a wireless receiver.

19. The head-mounted text display system for the hearing impaired as recited in claim 18, wherein the textual data is displayed to the user in passages containing three words at a time.

20. The head-mounted text display system for the hearing impaired as recited in claim 19, further comprising means for translating the spoken language into a selected second language, the textual data being displayed to the user in the second language.
